(19) United States
(12) Patent Application Publication
(10) Pub. No.: US 2012/0093056 A1
(43) Pub. Date: Apr. 19, 2012

(54) APPARATUS AND METHOD FOR MANAGING SLOT

(75) Inventors: Chang Sub Shin, Daejeon (KR); Wun-Cheol Jeong, Daejeon (KR); Tae Joon Park, Daejeon (KR); Hoyong Kang, Daejeon (KR); Se Ham Kim, Daejeon (KR); In Hwan Lee, Daejeon (KR); Cheol Sig Pyo, Daejeon (KR)

(73) Assignee: ELECTRONICS AND TELECOMMUNICATIONS RESEARCH INSTITUTE, Daejeon (KR)

(21) Appl. No.: 13/271,773

(22) Filed: Oct. 12, 2011

(30) Foreign Application Priority Data
Oct. 13, 2010 (KR) 10-2010-0099769
Sep. 14, 2011 (KR) 10-2011-0092610

(51) Int. Cl. H04W 72/04; H04W 4/06

(52) U.S. Cl. 370/312

(57) ABSTRACT

A slot managing method and apparatus is provided. A first layer of a destination node receives a request command for requesting a slot management from a source node, and transfers a first primitive for reporting a receipt of the request command to a second layer that is an upper layer of the first layer. The second layer transfers a second primitive to the first layer as a response to the slot management request. The first layer broadcasts a reply command including a result of the slot management request to neighboring nodes in response to the second primitive. The source node broadcasts a notify command including a result of the slot management request.

### CROSS-REFERENCE TO RELATED APPLICATION

This application claims priority to and the benefit of Korean Patent Application Nos. 10-2010-0099769 filed in the Korean Intellectual Property Office on Oct. 13, 2010 and 10-2011-0092610 filed in the Korean Intellectual Property Office on Sep. 14, 2011, the entire contents of which are incorporated herein by reference.

### BACKGROUND

(a) Field

The present invention relates to a slot managing method and apparatus.

(b) Description of the Related Art

Requirements for wireless sensor network systems are increased in industries requiring the reliability. Particularly, the high reliability and the minimization of a data transmission delay time between terminal nodes are required when transmitting data.

A wireless personal area network (WPAN) may be used as the wireless sensor network system. The WPAN is defined in, for example, the IEEE 802.15 standard. Particularly, the IEEE 802.15.4 defines medium access control (MAC) technologies of the WPAN.

The MAC technologies of the IEEE 802.15.4 are classified into a beacon mode and a non-beacon mode. In the beacon mode, a network is formed by a tree structure starting from a coordinator of a personal area network (PAN). Each node allocates an independent active duration according to a scheduling scheme supported by a user, and supports a communication during the active duration. However, because a mesh network cannot be supported in the beacon mode, the low reliability and the redundancy of paths, which are problems of the beacon mode, exist. Therefore, it is difficult to support services requiring the reliability and the low delay between the terminal nodes

Further, problems of a packet collision and a transmission delay exist in the non-beacon mode because all nodes use contention-based data transmission.

Therefore, in order to minimize the data transmission delay time between the terminal nodes and improve the reliability, a method for efficiently managing durations in which each node transmits data, i.e., time slots is required.

### SUMMARY

Embodiments of the present invention provide a slot managing method and apparatus for improving the reliability and minimizing a data transmission delay time between terminal nodes.

According to an embodiment of the present invention, a method of managing slots in a destination node is provided. The destination node includes a first layer and a second layer that is an upper layer of the first layer. In the method, the destination node receives a request command for requesting a slot management from a source node, and the first layer transfers a first primitive for reporting a receipt of the request command to the second layer. The second layer transfers a second primitive to the first layer as a response to the slot management request. The first layer broadcasts a reply command including a result of the slot management request to neighboring nodes in response to the second primitive. The destination node receives a notify command broadcasted from the source node, and the notify command includes a result of the slot management request.

The first layer may further transfer a third primitive for reporting a receipt of the notify command to the second layer.

The first layer may further transmit an acknowledgement message to the request command to the source node.

The slot management may include at least one of allocation of new slots, deallocation of existing slots, duplicated allocation notification of the existing slots, reduce of the existing slots, or restart of the existing slots.

The request command may include information indicating a status for existing slot allocation when the slot management corresponds to the allocation of new slots.

The source node may include a third layer and a fourth layer that is an upper layer of the third layer. In this case, the request command may be generated by a third primitive that is transferred from the fourth layer to the third layer, and a fourth primitive for reporting a receipt of the reply command may be transferred from the third layer to the fourth layer.

According to another embodiment of the present invention, a method of managing slots in a source node is provided. In the method, the source node transmits a request command for requesting a slot management to a destination node, and receives a reply command broadcasted from the destination node. The reply command includes a result of the slot management request. The source node broadcasts a notify command including a result of the slot management request to neighboring nodes. A first primitive for reporting a receipt of the request command is transferred from a first layer of the destination node to a second layer that is an upper of the first layer. The reply command is generated when the first layer receives a second primitive that is transferred from the second layer as a response to the slot management request.

A third primitive for reporting a receipt of the notify command may be transferred from the first layer to the second layer.

The source node may further receive an acknowledgement message to the request command from the destination node.

The slot management may include at least one of allocation of new slots, deallocation of existing slots, duplicated allocation notification of the existing slots, reduce of the existing slots, or restart of the existing slots.

The request command may include information indicating a status for existing slot allocation when the slot management corresponds to the allocation of new slots.

A third layer of the source node may further receive a third primitive for requesting the slot management from a fourth layer that is an upper layer of the third layer before transmitting the request command, and transfer a fourth primitive for reporting a receipt of the reply command to the fourth layer.

According to yet another embodiment of the present invention, a method of managing slots in a source node is provided. In the method, the source node transmits a request command to a destination node to request slot allocation information of the destination node, and receives a reply command including the slot allocation information from the destination node. The source node allocates slots based on the slot allocation information, and broadcasts a notify command including the allocated slot information to neighboring nodes. The source node receives a confirm command that is broadcasted as a response to the notify command from destination node, and the confirm command includes the allocated slot information.

A first layer of the source node may further receive a first primitive for requesting a slot allocation from a second layer that is an upper layer of the first layer before transmitting the request command, and transfer a second primitive for reporting a receipt of the reply command to the second layer. The second layer may further transfer a third primitive including the allocated slot information to the first layer before transmitting the notify command. The first layer may further transfer a fourth primitive for reporting a receipt of the confirm command to the second layer.

According to yet another embodiment of the present invention, a method of managing slots in a destination node is provided. In the method, the destination node receives a request command for requesting slot allocation information from the source node, and transmits a reply command including the slot allocation information to the source node. The destination node receives a notify command broadcasted from the source node, the notify command including allocated slot information, and broadcasts a confirm command including the allocated slot information to neighboring nodes in response to the notify command.

A first layer of the destination node may further transfer a primitive for reporting a receipt of the confirm command to a second layer that is an upper layer of the first layer.

According to yet another embodiment of the present invention, an apparatus for managing slots in a destination node is provided. The apparatus includes a first layer and a second layer being an upper layer of the first layer. The first layer receives a request command for requesting a slot management from a source node, generates a first primitive for reporting a receipt of the request command, broadcasts a reply command including a result of the slot management request to neighboring nodes, and receives a notify command broadcasted from the source node, the notify command including a result of the slot management request. The second layer receives the first primitive from the first layer and transmits a second primitive to the first layer as a response to the slot management request.

The first layer may further transfer a third primitive for reporting a receipt of the notify command to the second layer.

The first layer may further transmit an acknowledgement message to the request command to the source node.

The source node may include a third layer and a fourth layer that is an upper layer of the third layer. In this case, the request command may be generated by a third primitive that is transferred from the fourth layer to the third layer, and a fourth primitive for reporting a receipt of the reply command may be transferred from the third layer to the fourth layer.

### BRIEF DESCRIPTION OF THE DRAWINGS

FIG. 1 and FIG. 2 are drawings showing a structure of a multi-superframe in a wireless sensor network system according to an embodiment of the present invention.

FIG. 3 and FIG. 5 are schematic drawings showing a slot managing method according to an embodiment of the present invention.

FIG. 4 and FIG. 6 are signal flowcharts showing a slot managing method according to an embodiment of the present invention.

### DETAILED DESCRIPTION OF THE EMBODIMENTS

In the following detailed description, only certain embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

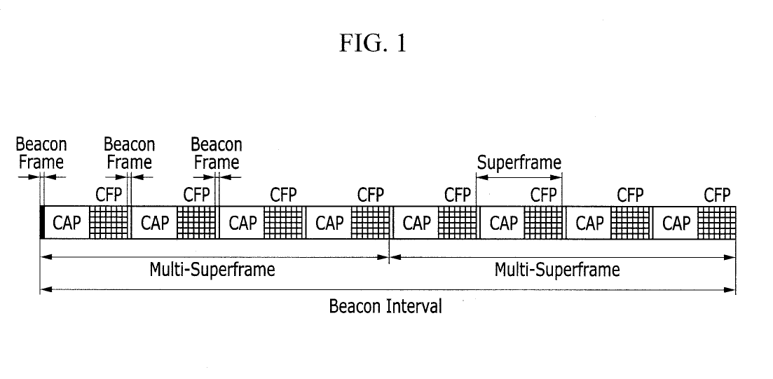

FIG. 1 is a drawing showing a structure of a multi-superframe in a wireless sensor network system according to an embodiment of the present invention.

Referring to FIG. 1, the multi-superframe corresponds to a cycle of repeated superframes, and includes a plurality of superframes. The plurality of superframes, for example two superframes configures a beacon interval. Each superframe includes a beacon frame, a contention access period (CAP), and a contention free period (CFP). Each node transmits or receives a beacon in the beacon frame. A plurality of slots are allocated to the CFP. The CFP is divided into a plurality of time slots in a time axis direction, and is divided into a plurality of channels in a frequency axis direction. An area defined by one time slot and one channel corresponds to a slot. This slot may be referred to as a deterministic and synchronous multi-channel extension guaranteed time slot (DSME-GTS). The DSME-GTS may be defined by a slot number and a channel number.

Since the number of DSME-GTSs that a signal node can use is restricted, the multi-superframe is used by grouping the plurality of superframe as shown in FIG. 1. The size and structure of the multi-superframe may depend on values of beacon order (BO), superframe order (SO) and multi-superframe order (MO). The BO denotes an interval at which a coordinator transmits the beacon frame, and the SO denotes the length of the superframe. The MO denotes the length of the multi-superframe, which is a cycle of a repeated DSME-GTS allocation schedule.

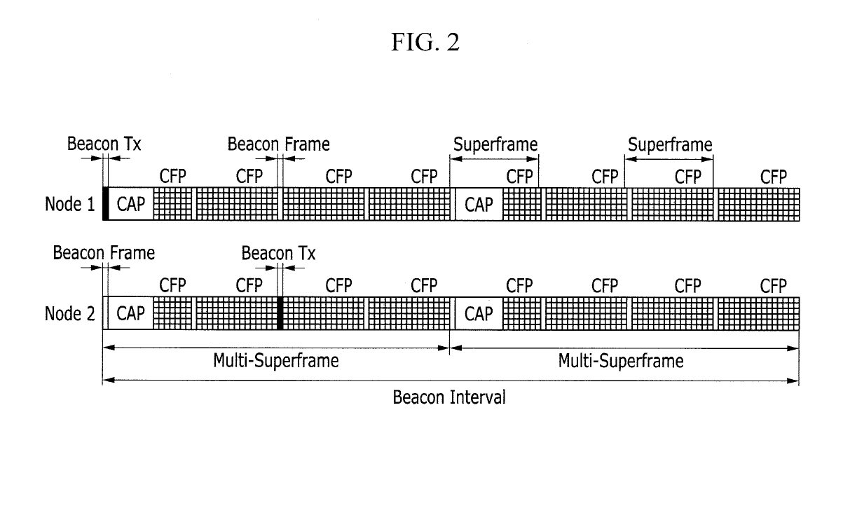

FIG. 2 is a drawing showing a structure of a multi-superframe in a wireless sensor network system according to another embodiment of the present invention.

Referring to FIG. 2, the number of CAPs for each multi-superframe is set to 1 such that the number of DSME-GTSs is increased in a multi-superframe and transmission delay is reduced. The CAP is located after the first beacon frame of the multi-superframe. In the case of the second beacon frame or beacon frames subsequent to the second beacon frames in the multi-superframe, the CAP does not follow immediately after the beacon frames. Thus, the beacon frame may specify a time when a next CAP starts.

In FIG. 2, a node 1 transmits a beacon at the first beacon frame, and a node 2 transmits a beacon at the third beacon frame.

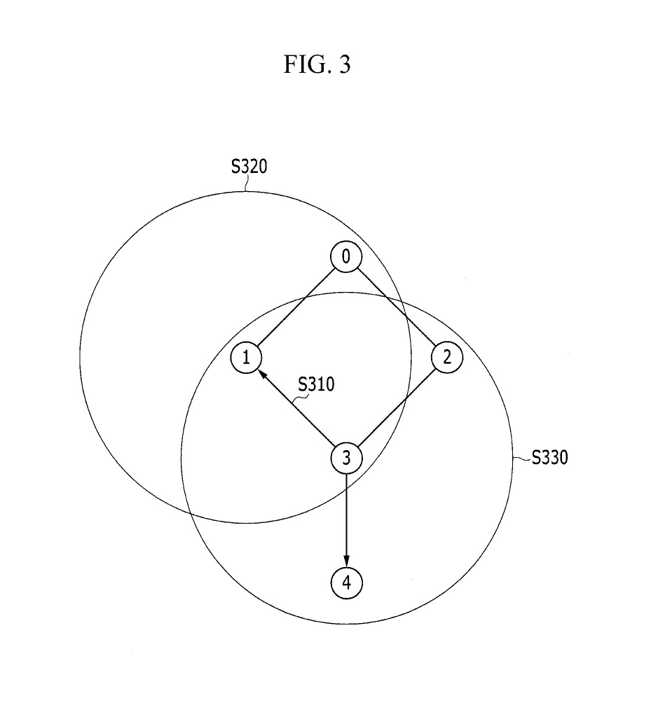

Hereinafter, a slow managing method according to various embodiments of the present invention will be described with reference to FIG. 3 to FIG. 6.

FIG. 3 is a schematic drawing showing a slot managing method according to an embodiment of the present invention.

In FIG. 3, it is assumed that a node 3 transmits a request of a slow allocation to a node 1, and slots for data transmission have been already allocated between a node 4 and the node 3.

Referring to FIG. 3, the node 3 transmits a DSME-GTS request command for requesting the slot allocation to a node (S310). The DSME-GTS request command includes the number of slots that it is requesting and DSME slot allocation bitmap (SAB) sub-block information. DSME SAB sub-block information may have a bitmap format, and indicates readily allocated or unavailable slots (for example, bits with ‘1’ in the bitmap) and available slots (for example, bits with ‘0’ in the bitmap).

The node 1 allocates slots for the node 3, and broadcasts a DSME-GTS reply command including the allocated slot information and a destination address to neighboring nodes (S320). The allocated slots information includes DSME SAB sub-block information, and the destination address is an address of the node 3. Then, the nodes 0 and 3 that are the neighboring nodes of node 1 receive DSME-GTS reply command.

The node 3 corresponding to the destination of the DSME-GTS reply command broadcasts a DSME-GTS notify command including allocated slot information and a destination address to the neighboring nodes, thereby notifying the neighboring nodes of the result of allocation (S330). The allocated slot information includes DSME SAB sub-block information, and the destination address is an address of the node 1. Then, the nodes 1, 2 and 4 that are the neighboring nodes of the node 3 receive the DSME-GTS notify command.

As such, according to an embodiment of the present invention, the node 1, i.e., a destination node allocates slots such that the slots can be allocated by exchange of three commands. As a result, a transmission delay time can be minimized. Further, the nodes 0, 2 and 4 corresponding to the neighboring nodes of the nodes 1 and 3 can update current slot information by the broadcasted command frame, so the reliability of the slot allocation can be improved.

While it has been described in FIG. 3 that the slots are allocated by the DSME-GTS request command, the DSME-GTS reply command, and the DSME-GTS notify command, these commands can be used for the other managements of the slots as well as the allocation of the slots. The management type may be allocation of new slots, or deallocation, duplicated allocation notification, reduce, or restart of existing slots.

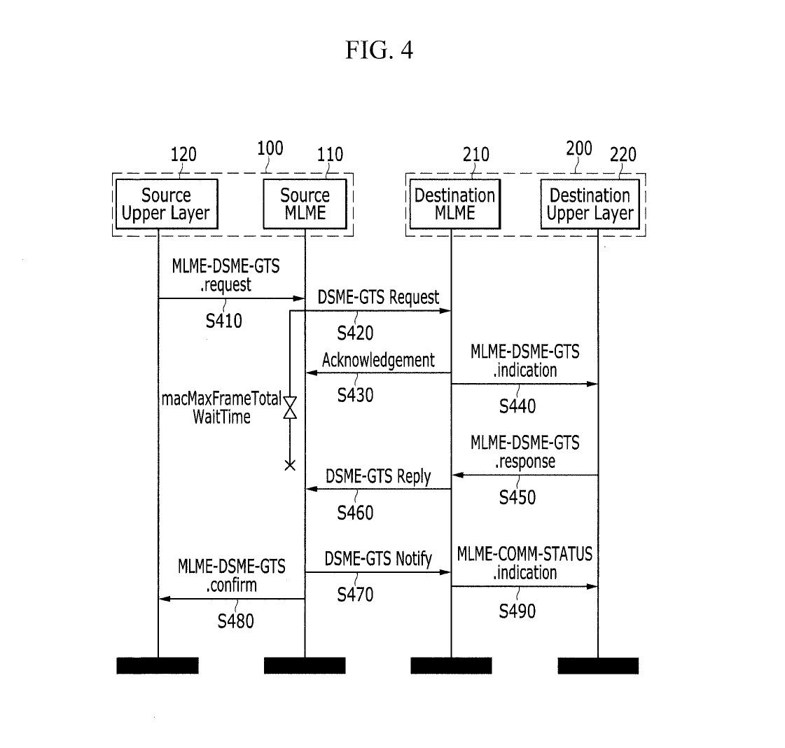

FIG. 4 is a signal flowchart of a slot managing method according to an embodiment of the present invention.

Referring to FIG. 4, a source node 100 includes a MAC sublayer management entity (MLME) (hereinafter referred to as “a source MLME”) 110 and an upper layer (hereinafter referred to as “source upper layer”) 120 of the MLME 110. A destination node 200 also includes an MLME (hereinafter referred to as “a destination MLME”) 210 and an upper layer (hereinafter referred to as “a destination upper layer”) 220. The source node 100 may request management of slots to the destination node 200.

The source upper layer 120 transfers an MLME-DSME-GTS.request primitive that is a primitive for requesting a slot management to the source MLME 110 (S410). Then, the source MLME 110 transmits the DSME-GTS request command for requesting the slot management to the destination MLME 210 (S420). The destination MLME 210 may transmit an acknowledgement message on the DSME-GTS request command to the source MLME 110 (S430).

Next, the destination MLME 210 transfers an MLME-DSME-GTS.indication primitive for reporting the receipt of the DSME-GTS request command to the upper layer 220 of the destination node 200 (S440). The destination upper layer 220 performs the requested management for the source node 110 in accordance with the MLME-DSME-GTS.indication primitive, and transfers an MLME-DSME-GTS.response primitive as a response to the destination MLME 210 (S450). The requested management is allocation of new slots, or deallocation, duplicated allocation notification, reduce, or restart of existing slots. Then, the destination MLME 210 broadcasts a DSME-GTS reply command to neighboring nodes including the source node 100, to report the result of management request (S460).

The source MLME 110 broadcasts a DSME-GTS notify command to neighboring nodes including the destination node 200, to report the result of management request (S470). Further, the source MLME 110 transfers an MLME-DSME-GTS.confirm primitive to the upper layer 120 to report the result of management request (S480). The destination MLME 210 reports the receipt of the DSME-GTS notify command to the upper layer 220 using an MLME-COMM-STATUS.indication primitive (S490).

Next, parameters of the commands and primitives described in FIG. 4 will be described with reference to Tables 1 to 5.

Referring to Table 1, a frame of the DSME-GTS request command includes a MAC header (MHR) field, a command frame identifier (ID) field, a DSME-GTS management field, a number of slots field, a preferred superframe ID field, a preferred slot ID field, and a DSME SAB specification field.

TABLE 1

| Octets | Variable | 1 | 1 | 0/1 | 0/2 | 0/1 | Variable |
|---|---|---|---|---|---|---|---|
| Name | MHR | Command | DSME-GTS | Number | Preferred | Preferred | DSME SAB |
| | | frame ID | management | of slots | superframe | slot ID | specification |
| | | | | | ID | | |

The MHR field includes a source address and a destination address. The DSME-GTS management field includes a management type, and the management type has information of Table 2 in accordance with its value. The number of slots, the preferred superframe ID, and the preferred slot ID exist when the management type indicates “allocation”. The number of slots indicates the number of DSME-GTSs that a corresponding command requests, the preferred superframe ID indicates an index of a preferred superframe in which the DSME-GTSs need be allocated, and the preferred slot ID indicates an index of a preferred slot from which the DSME-GTSs need be allocated. The DSME SAB specification includes DSME SAB sub-block information to be managed, and may have a bitmap format. When the management type is “allocation”, the DSME SAB sub-block information indicates readily allocated or unavailable slots (for example, bits with ‘1’ in the bitmap) and available slots (for example, bits with ‘0’ in the bitmap). When the management type is not “allocation”, the DSME SAB sub-block information slots (for example, bits with “1” in the bitmap) to be managed, that is, slots that are being requested deallocation, duplicated allocation notification, reduce, or restart. The DSME SAB specification may further include a length of DSME SAB sub-block and an index indicating the beginning of the DSME SAB sub-block.

TABLE 2

| Management Type value b₂b₁b₀ | Description |
|---|---|
| 000 | Deallocation |
| 001 | Allocation |
| 010 | Duplicated Allocation Notification |
| 011 | Reduce |
| 100 | Restart |
| 101 | DSME-GTS Expiration |
| 110-111 | Reserved |

Referring to Table 3, a frame of the DSME-GTS reply command includes an MHR field, a command frame ID field, a DSME-GTS management field, a destination address field, a channel offset field, and a DSME SAB specification field. Since the DSME-GTS reply command is broadcasted, a destination address of the MHR is set to a broadcast address. The destination address field includes an address of a destination of the DSME-GTS reply command, i.e., an address of the source node 100. The DSME-GTS management field includes a status as well as a management type, and the status indicates the result of the DSME-GTS request. A DSME SAB sub-block of the DSME SAB specification indicates slots that are selected for allocation, deallocation, duplicated allocation notification, reduce, or restart.

TABLE 3

| Octets | Variable | 1 | 1 | 2 | 0/1 | Variable |
|---|---|---|---|---|---|---|
| Name | MHR | Com- | DSME- | Desti- | Channel | DSME |
| | | mand | GTS | nation | offset | SAB |
| | | frame | manage- | ad- | | speci- |
| | | ID | ment | dress | | fication |

A frame of the DSME-GTS notify command also includes an MHR field, a command frame ID field, a DSME-GTS management field, a destination address field, a channel offset field, and a DSME SAB specification field as Table 3. Since the DSME-GTS notify command is broadcasted, a destination address of the MHR is set to a broadcast address. The destination address filed includes an address of a destination of the DSME-GTS notify command, i.e., an address of the destination node 200. A DSME SAB sub-block of the DSME SAB specification indicates slots that are selected for allocation, deallocation, duplicated allocation notification, reduce, or restart.

Referring to FIG. 4, the MLME-DSME-GTS.request primitive is generated the source upper layer 120, and is transferred to the source MLME 110 to request a slot management. When receiving MLME-DSME-GTS.request primitive from the upper layer 120, the source MLME 110 transmits the DSME-GTS request command to the destination MLME 220. Therefore, the MLME-DSME-GTS.request primitive includes a device address, and a management type, a number of slots, a preferred superframe, a preferred slot ID and a DSME SAB specification that are described in the DSME-GTS request command. The device address indicates an address of a neighboring node to request the management of the DSME-GTS, that is, an address of the destination node 200.

The MLME-DSME-GTS.indication primitive is generated by the destination MLME 210, and is transferred to the upper layer 220 upon the reception of the DSME-GTS request command. Therefore, the MLME-DSME-GTS.request primitive includes a device address, and a management type, a number of slots, a preferred superframe, a preferred slot ID and a DSME SAB specification that are described in the DSME-GTS request command. The device address indicates an address of a node that has transmitted the DSME-GTS request command, that is, an address of the source node 100.

The MLME-DSME-GTS.response primitive is generated by the destination upper layer 220, and is transferred to the destination MLME 210 to respond the management of the DSME-GTS. Therefore, the MLME-DSME-GTS.response primitive includes a device address, a management type, and a DSME SAB specification and a status that are described in the DSME-GTS reply command. The device address indicates an address of a node that has transmitted the received DSME-GTS request command, that is, the address of the source node 100.

When receiving the DSME-GTS reply command, the source MLME 110 checks whether the status indicates “success” when the destination address of the DSME-GTS reply command is the same as its own address. When the status indicates “success”, the source MLME 110 generates the DSME-GTS notify command and transmits it to the destination node 220. Further, the source MLME 110 generates the MLME-DSME-GTS.confirm primitive to notify the upper layer 120 of the result of the management request. Therefore, the MLME-DSME-GTS.confirm primitive includes a device address, and a management type, a DSME SAB specification and a status that are described in the MLME-DSME-GTS.response primitive. The device address indicates an address of a node that has transmitted DSME-GTS reply command, that is, the address of the destination node 100. When the destination address of the DSME-GTS reply command is different to its own address, the source MLME 110 updates its own DSME SAB based on the DSME SAB specification of the DSME-GTS reply command to reflect the DSME-GTS management result of the neighboring node.

When the destination address of the received DSME-GTS notify command is the same as its own address, the destination MLME 210 notifies the upper layer 220 of the receipt of the DSME-GTS notify command using the MLME-COMM-STATUS.indication primitive. When the device address of the DSME-GTS notify command is different to its own address, the destination MLME 210 updates its own DSME SAB based on the DSME SAB specification of the DSME-GTS notify command to reflect the DSME-GTS management result of the neighboring node.

Referring to FIG. 4 again, if the source MLME 110 does not receive the acknowledge message after transmitting the DSME-GTS request command to the destination node 200 (S420), the source MLME 110 transfers the MLME-DSME-GTS.confirm primitive with a status of NO_ACK (a receipt failure of the acknowledgement message) to the upper layer 120 (S480).

If the source node 100 receives no DSME-GTS reply command during a wait time after transmitting the DSME-GTS request command (S420), the source node 100 transfers the MLME-DSME-GTS.confirm primitive with a status of NO_DATA (a receipt failure of data) to the upper layer 120 (S480). The wait time may be represented as a maximum wait time (macMaxFrameTotalWaitTime) of a MAC layer.

As described above, according to an embodiment of the present, since the slots can be allocated by the exchange of the three command frames and the primitive exchange between the MLME and the upper layer, the data delay can be minimized. Further, since the slot information of the neighboring node can be updated by the DSME-GTS reply command and the DSME-GTS notify command, the reliability of slot allocation can be improved.

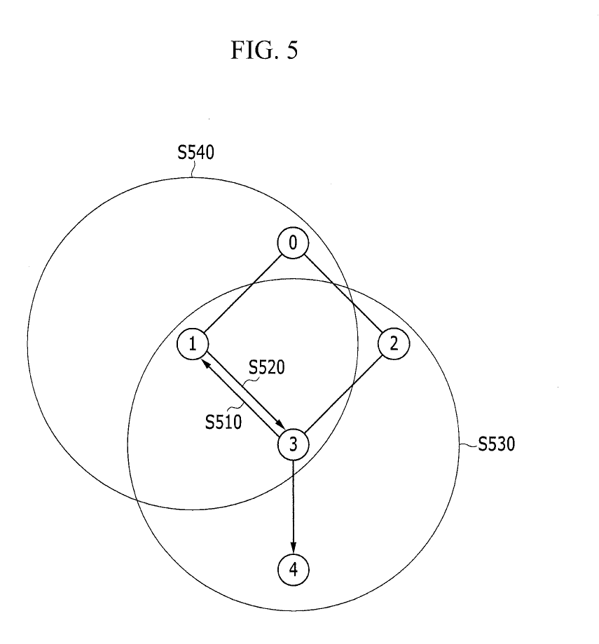

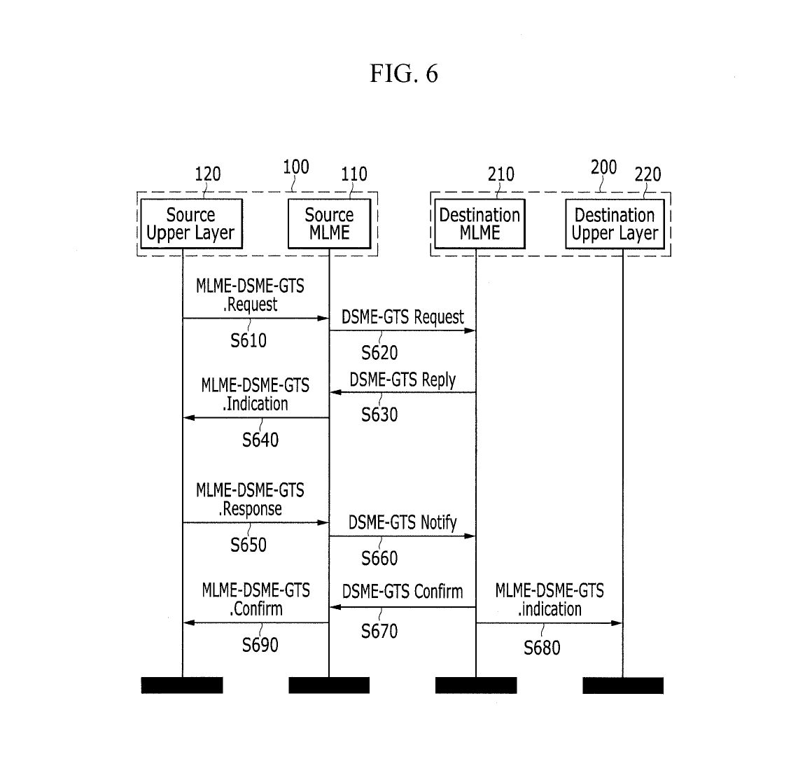

Next, a slot managing method according to another embodiment of the present invention will be described with reference to FIG. 5 and FIG. 6.

FIG. 5 is a schematic drawing showing a slot managing method according to another embodiment of the present invention, and FIG. 4 is a signal flowchart of a slot managing method according to another embodiment of the present invention.

In FIG. 5, it is assumed that a node 3 transmits a request of a slow allocation to a node 1, and slots for data transmission have been already allocated between a node 0 and the node 1.

Referring to FIG. 5, the node 3 requesting a slot allocation transmits a DSME-GTS request command to the node 1, thereby requesting slot allocation information (S510). Then, the node 1 transmits a DSME-GTS reply command including its own slot allocation information to the node 3 (S520). The slot allocation information includes DSME-GTS sub-block information. In an example of FIG. 5, the DSME-GTS sub-block information indicates that the slots allocated between the node 0 and the node 1 are being used. The node 3 compares the slot allocation information received through the DSME-GTS reply command with its own slot allocation information, to determine slots to be allocated among available slots. The node 3 broadcasts a DSME-GTS notify command including the allocated slot information and a destination address to neighboring nodes (S530). The allocated slot information includes a DSME SAB sub-block information, and the destination address is an address of the node 1. Then, nodes 1, 2 and 4 that are the neighboring nodes of the node 3 receive the DSME-GTS notify command. When the destination address of the DSME-GTS reply command is its own address, the node 1 broadcasts a DSME-GTS confirm command including the allocated slot information and a destination address to neighboring nodes, as confirm of the DSME-GTS notify command (S540). The allocated slot information includes a DSME SAB sub-block information, and the destination address is an address of the node 3. Then, the nodes 0 and 3 that are the neighboring nodes of the node 1 receive the DSME-GTS confirm command.

While it has been described in FIG. 5 that the slots are allocated by the DSME-GTS request command, the DSME-GTS reply command, the DSME-GTS notify command, and the DSME-GTS confirm command, these commands can be used for the other managements of the slots as well as the allocation of the slots as described in FIG. 3 and FIG. 4.

Next, a primitive exchange between an MLME and an upper layer according to commands described will be described with reference to FIG. 6.

Referring to FIG. 6, a source upper layer 120 transfers a MLME-DSME-GTS.request primitive that is a primitive for requesting a slot allocation to a source MLME 110 (S610). Then, the source MLME 110 transmits a DSME-GTS request command to a destination node 200 (S620). A destination MLME 210 transmits a DSME-GTS reply command to a source node 100 as a response to the DSME-GTS request command (S630), and the source MLME 110 transfers a MLME-DSME-GTS.indication primitive for reporting the reception of the DSME-GTS reply command to the upper layer 120 (S640).

The source upper layer 120 compares slot allocation information received through the MLME-DSME-GTS.indication primitive with its own slot allocation information, to determine slots to be allocated among available slots, and transfers a MLME-DSME-GTS.response primitive including the allocated slot information to the MLME 110 (S650). Then, the source MLME 110 broadcasts a DSME-GTS notify command (S660), and the destination MLME 210 broadcasts DSME-GTS confirm command as a response to the DSME-GTS notify command (S670). The destination MLME 210, which receives the DSME-GTS notify command having its own address as the destination address, transfers a MLME-DSME-GTS.indication primitive for reporting the result of the slot allocation, i.e., the slot management to the upper layer 220 (S680). Further, the source MLME 110, which receives the DSME-GTS confirm command having its own address as the destination address, transfers a MLME-DSME-GTS.confirm primitive for reporting this to the upper layer 120 (S690).

As such, according to an embodiment described with reference to FIG. 5 and FIG. 6, the slots can be allocated by the exchange of the four command frames since the source node allocates the slots. As a result, the data transmission delay time can be minimized. Further, the neighboring nodes of the source and destination nodes can update current slot information by the broadcasted command frame, so the reliability of slot allocation can be improved.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

What is claimed is:

1. A method of managing slots in a destination node including a first layer and a second layer that is an upper layer of the first layer, the method comprising:
receiving a request command for requesting a slot management from a source node;
transferring a first primitive for reporting a receipt of the request command from the first layer to the second layer;
transferring a second primitive from the second layer to the first layer, as a response to the slot management request;
broadcasting a reply command including a result of the slot management request to neighboring nodes in response to the second primitive in the first layer; and
receiving a notify command broadcasted from the source node, the notify command including a result of the slot management request.

2. The method of claim 1, further comprising transferring a third primitive for reporting a receipt of the notify command from the first layer to the second layer.

3. The method of claim 1, further comprising transmitting an acknowledgement message to the request command to the source node in the first layer.

4. The method of claim 1, wherein the slot management includes at least one of allocation of new slots, deallocation of existing slots, duplicated allocation notification of the existing slots, reduce of the existing slots, or restart of the existing slots.

5. The method of claim 4, wherein the request command includes information indicating a status for existing slot allocation when the slot management corresponds to the allocation of new slots.

6. The method of claim 1, wherein the source node includes a third layer and a fourth layer that is an upper layer of the third layer,
the request command is generated by a third primitive that is transferred from the fourth layer to the third layer, and
a fourth primitive for reporting a receipt of the reply command is transferred from the third layer to the fourth layer.

7. A method of managing slots in a source node, the method comprising:
transmitting a request command for requesting a slot management to a destination node;
receiving a reply command broadcasted from the destination node, the reply command including a result of the slot management request; and
broadcasting a notify command including a result of the slot management request to neighboring nodes,
wherein a first primitive for reporting a receipt of the request command is transferred from a first layer of the destination node to a second layer that is an upper of the first layer, and
the reply command is generated when the first layer receives a second primitive that is transferred from the second layer as a response to the slot management request.

8. The method of claim 7, wherein a third primitive for reporting a receipt of the notify command is transferred from the first layer to the second layer.

9. The method of claim 7, further comprising receiving an acknowledgement message to the request command from the destination node.

10. The method of claim 7, wherein the slot management includes at least one of allocation of new slots, deallocation of existing slots, duplicated allocation notification of the existing slots, reduce of the existing slots, or restart of the existing slots.

11. The method of claim 10, wherein the request command includes information indicating a status for existing slot allocation when the slot management corresponds to the allocation of new slots.

12. The method of claim 7, further comprising:
receiving, by a third layer of the source node, a third primitive for requesting the slot management from a fourth layer that is an upper layer of the third layer before transmitting the request command; and
transferring, by the third layer, a fourth primitive for reporting a receipt of the reply command to the fourth layer.

13. A method of managing slots in a source node, the method comprising:
transmitting a request command to a destination node to request slot allocation information of the destination node;
receiving a reply command including the slot allocation information from the destination node;
allocating slots based on the slot allocation information;
broadcasting a notify command including the allocated slot information to neighboring nodes; and
receiving a confirm command that is broadcasted as a response to the notify command from destination node, the confirm command including the allocated slot information.

14. The method of claim 13, wherein further comprising:
receiving, by a first layer of the source node, a first primitive for requesting a slot allocation from a second layer that is an upper layer of the first layer before transmitting the request command;
transferring, by the first layer, a second primitive for reporting a receipt of the reply command to the second layer;
transferring, by the second layer, a third primitive including the allocated slot information to the first layer before transmitting the notify command; and
transferring, by the first layer, a fourth primitive for reporting a receipt of the confirm command to the second layer.

15. A method of managing slots in a destination node, the method comprising:
receiving a request command for requesting slot allocation information from the source node;
transmitting a reply command including the slot allocation information to the source node;
receiving a notify command broadcasted from the source node, the notify command including allocated slot information; and
broadcasting a confirm command including the allocated slot information to neighboring nodes in response to the notify command.

16. The method of claim 15, further comprising transferring, by a first layer of the destination node, a primitive for reporting a receipt of the confirm command to a second layer that is an upper layer of the first layer.

17. An apparatus for managing slots in a destination node, the apparatus comprising:
a first layer configured to receive a request command for requesting a slot management from a source node, generate a first primitive for reporting a receipt of the request command, broadcast a reply command including a result of the slot management request to neighboring nodes, and receive a notify command broadcasted from the source node, the notify command including a result of the slot management request; and
a second layer configured to receive the first primitive from the first layer and transmit a second primitive to the first layer as a response to the slot management request, the second layer being an upper layer of the first layer.

18. The apparatus of claim 17, wherein the first layer is further configured to transfer a third primitive for reporting a receipt of the notify command to the second layer.

19. The apparatus of claim 17, wherein the first layer is further configured to transmit an acknowledgement message to the request command to the source node.

20. The apparatus of claim 17, wherein the source node includes a third layer and a fourth layer that is an upper layer of the third layer,
the request command is generated by a third primitive that is transferred from the fourth layer to the third layer, and
a fourth primitive for reporting a receipt of the reply command is transferred from the third layer to the fourth layer.
